(19) United States
(12) Patent Application Publication
(10) Pub. No.: US 2018/0200631 A1
(43) Pub. Date: Jul. 19, 2018

(54) TARGET BASED GAMES PLAYED WITH ROBOTIC AND MOVING TARGETS

(71) Applicant: Kenneth C. Miller, Aptos, CA (US)

(72) Inventor: Kenneth C. Miller, Aptos, CA (US)

(21) Appl. No.: 15/867,856

(22) Filed: Jan. 11, 2018

Related U.S. Application Data
(60) Provisional application No. 62/446,054, filed on Jan. 13, 2017.

(51) Int. Cl. A63F 13/837; A63F 13/213; A63F 13/67; A63F 13/31

(52) U.S. Cl. CPC A63F 13/837; A63F 13/31; A63F 13/67; A63F 13/213

(57) ABSTRACT

A target gaming system is provided that includes at least one target having an optical sensor. The target is adapted to move untethered around in a targeting area. At least one weapon is provided that emits an optical signal recognized by the optical sensor. The optical signal contacting the optical sensor constitutes a scoring hit. A game is provided with players are allocated to form teams, each player having an optical sensor weapon and the targeting area is an arena or sporting venue.

### RELATED APPLICATIONS

This application is a non-provisional application that claims priority benefit of U.S. provisional application 62/446,054 filed on Jan. 13, 2017; the contents of which are hereby incorporated by reference.

### FIELD OF THE INVENTION

The present invention in general relates to entertainment and games, and in particular to target based games played with robotic and moving targets.

### BACKGROUND OF THE INVENTION

Traditional shooting galleries have targets that are fixed in one place or have targets that move in a limited trajectory, which is typically linear. These galleries are also static and complex to install and maintain. As a result, there is limited appeal in repetitive play and motivation to routinely modify a given gallery. With the advent of computer games, augmented reality, laser tag, paint ball, and other live action games, the popularity and appeal of traditional shooting galleries continues to wane.

Thus, there exists a need for enhanced forms of shooting games that provide new gaming aspects and target movements to increase mass appeal of target shooting based games.

### SUMMARY OF THE INVENTION

A target gaming system is provided that includes at least one target having an optical sensor. The target is adapted to move untethered around in a targeting area. At least one weapon is provided that emits an optical signal recognized by the optical sensor. The optical signal contacting the optical sensor constitutes a scoring hit. A game is provided with players are allocated to form teams, each player having an optical sensor weapon and the targeting area is an arena or sporting venue.

### BRIEF DESCRIPTION OF THE DRAWINGS

FIG. 1A is a side view of an embodiment of a robot operative in the present invention;

FIG. 1B is a bottom view of the robot shown in FIG. 1A;

FIG. 2 is a side view of an embodiment of a targeting weapon with a laser or infra-red (IR) emitter with a smartphone or tablet attached operative in the present invention;

FIG. 3 is a system view showing communication between a central computer and the target weapons and targets themselves in accordance with embodiments of the invention; and

FIG. 4 is an illustration of a stadium venue with the seating divided into four sections for grouping participants in a target game competition in accordance with embodiments of the invention.

### DETAILED DESCRIPTION OF THE INVENTION

The present invention has utility as an enhanced shooting game that provides novel gaming aspects in general and in some embodiments, randomized or complex target movements. Embodiments of the invention provide a system of robots and electronics that enable a series of shooting targets to move around in random patterns, complex movement patterns, and do so with movements in a targeting area all without using of guidewires or other formed of tethers such that the robotic targets operate physically untethered and dwell in the shooting area, in contrast to skeet shooting type games where are target sails through the shoot area only once. The shooting targets according to the present invention may be controlled to change availability to a particular shooter, change scoring, and become temporally active, change speed and/or trajectories in response to feedback as to shooter proficiency, or a combination thereof. The robotic targets may have target sensors that detect being shot by a player in the shooting game. Target sensors illustratively include laser and infra-red (IR) sensors. In a particular inventive embodiment, a series of lights on each of the robotic targets provide information to each of the shooters playing in a game. Information provided by the lights on the robotic targets illustratively include: lights that turn on when a target is active (or alternatively turn off when the target in inactive), change color to indicate which player scores when the target is hit (each player assigned a color), change color and/or flash/pulse to indicate point values of the target to be shot at. One or more targets mounted to a robot may rotate or move independently from the movement of the robot itself. Robots may move in a random fashion, or in a programmed sequence. In a specific embodiment the target robots may run on a series of tracks/rails, by which, for example, a model railroad set may be turned into a shooting gallery.

Players who are shooting at the targets may use a dedicated laser or infra-red (IR) gun or rifle. A smartphone or tablet device may be combined with a laser or IR source to form a gun for firing at the targets, where the smartphone or tablet serves as an information display for gamming parameters, as well as providing communication in some embodiments with robotic targets via existing protocals such Bluetooth or WiFi, a trigger for the laser or IR source, a display source for augmented reality scenes, and as a target site for aiming at the targets. In a specific inventive embodiment, the phone or tablet itself may generate a focused light source to strike the target sensors. The laser or IR beam generated by the dedicated laser/IR gun, smartphone, or tablet may be pulsed in a coded pattern to identify to the target which user weapon recorded the “hit”.

In a specific inventive embodiment, the camera optics of the smartphone or tablet are used to lock in on a target (target acquisition) and record a “target hit” without having to actually “fire” the laser or IR beam. With target acquisition the phone or tablet would record the user's score. A tactile or haptic response may be provided by the phone or tablet when a target has been acquired and hit. For example, the smartphone may vibrate when a target is hit.

In a specific inventive embodiment, a user may use a head mounted weapon with heads up display (HUD) to aim and fire at targets, as well as view gaming statistics. Voice activation may be used to fire the user weapons from the head mounted weapon.

An application (app) may be downloaded to the weapons, smartphones and tablets used by players to play versions of targeting games. Player weapons and game targets may be networked via a local or Internet based network to record individual player performance in competitions and to control and record information from the targets. Various wireless radio frequency (RF) communication protocols may be used to connect elements (player weapons, targets, computer server) within the game illustratively including Bluetooth, WiFi, and nearfield communications. In an embodiment competing players may take turns controlling the movements of the robotic targets as the other player(s) take turns shooting at the targets.

In addition to targets affixed to robots, targets may be carried or worn by people moving around on foot or riding on a bike or motorized vehicle. In addition, targets may be mounted on vehicles illustratively including cars, trucks, and buses; whether actual or remote-controlled models thereof, a drone, or a combination of any of the aforementioned. The targets may be stationary while the game playing shooters move around with targets that could be mounted on anything, thereby turning player's surroundings into an ad hoc shooting gallery game, which unlike augmented reality (AR) games would have physical targets instead of virtual AR targets.

While a game can be handicapped a priori by given a more skilled player less scoring points to hitting a target, compared to a novice player, or a post game weighting can be applied as are conventional to many sporting events, in certain embodiments of the present invention an algorithm is employed that creates a change in robotic target behavior in response to the actual performance of a given player. By way of example, targets for a more skilled player have movement behavior with random trajectories, jinxs, accelerate erratically, stop and reverse, or a combination thereof all to make scoring more difficult compared to targets for a novice player that suspend these additional attributes.

In specific inventive embodiments, the targets may be quick response (QR) or bar Codes on cards that are mounted to various moving platforms. The codes are read by the user's tablet or smartphone. The platforms could still change color to indicate which team should be shooting at which target.

In specific inventive embodiments the robotic targets or other types of targets may be deployed on the playing surface in an arena where hundreds and even thousands of players may participate in a competition to gain the most points by hitting the most targets. For example, an arena may be divided into four quadrants where participants sign on to an app by scanning their ticket stub to provide a unique identity and a location. A competition may be held between quadrants, for example in a pause in a sporting event, where the quadrant that has the most target hits wins a prize. In another competition several elimination rounds may be held until an individual winner is determined. For example, in each round the top quarter of participants with the most target hits advance to the next round. The timing of target games within arenas may be set so as to be completed during halftimes, intermissions, or between periods of an athletic event or concert.

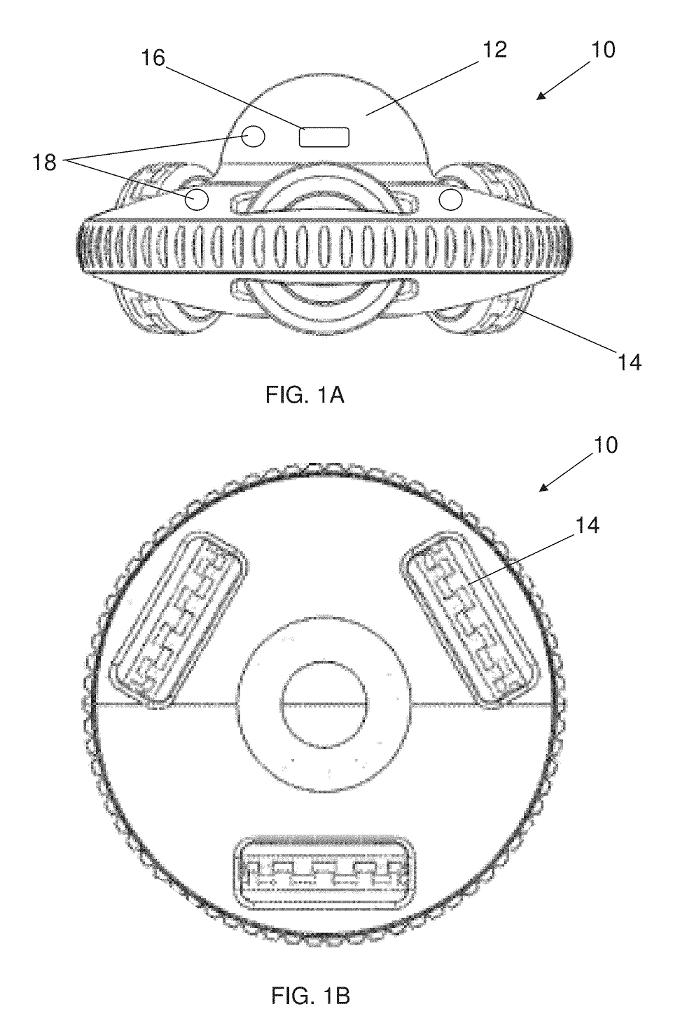

Referring now to the figures, FIG. 1A is a side view of an embodiment of a robot 10 that may be used as a target in embodiments of the invention. The robot 10 has a clear dome 12 that may house target sensors 16 illustratively including laser and infra-red (IR) sensors. In an embodiment a series of lights 18 in the dome 12 or on each of the robotic targets 10 provide information to each of the shooters playing in a game. A series of wheels 14 directionally propel the robot 10. FIG. 1B is a bottom view of the robot 10 shown in FIG. 1A.

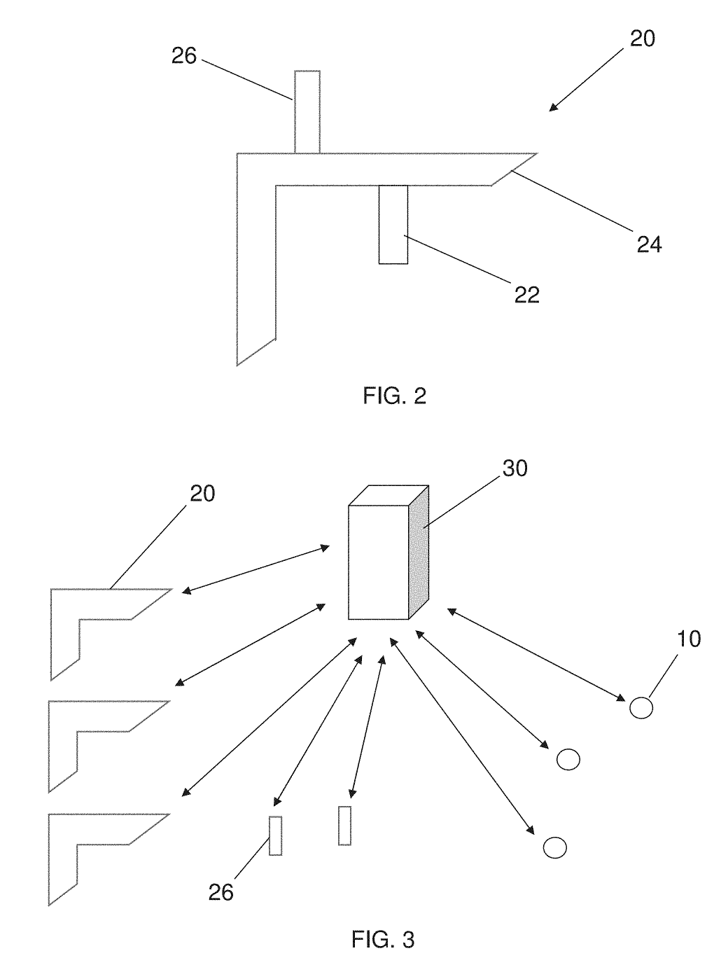

FIG. 2 is a side view of an embodiment of a targeting weapon 20 with a trigger 22 and a laser or infra-red (IR) emitter 24. A smartphone or tablet 26 may be attached to the targeting weapon 20, where the smartphone or tablet 26 serves as an information display for gamming parameters, a trigger means for the laser or IR source, a display source for augmented reality scenes, and as a target site for aiming at the targets. It is noted that in a specific embodiment the phone or tablet 26 itself may generate a focused light source to strike the target sensors.

FIG. 3 is a system view showing communication (shown as arrows) between a central computer 30, which may be a remote server in the cloud, and the target weapons 20, phones and tablets 26, and the targets 10. The central computer 30 may provide the app for game playing, and may collect data from each of the game players in competitions. The targets 10 communicate their status to the central computer 30, and the central computer 30 may control the movement of the robots 10. Communications may be carried over a local or Internet based network. Various wireless radio frequency (RF) communication protocols may be used to connect elements (player weapons, targets, computer server) within the game illustratively including Bluetooth, WiFi, and nearfield communications.

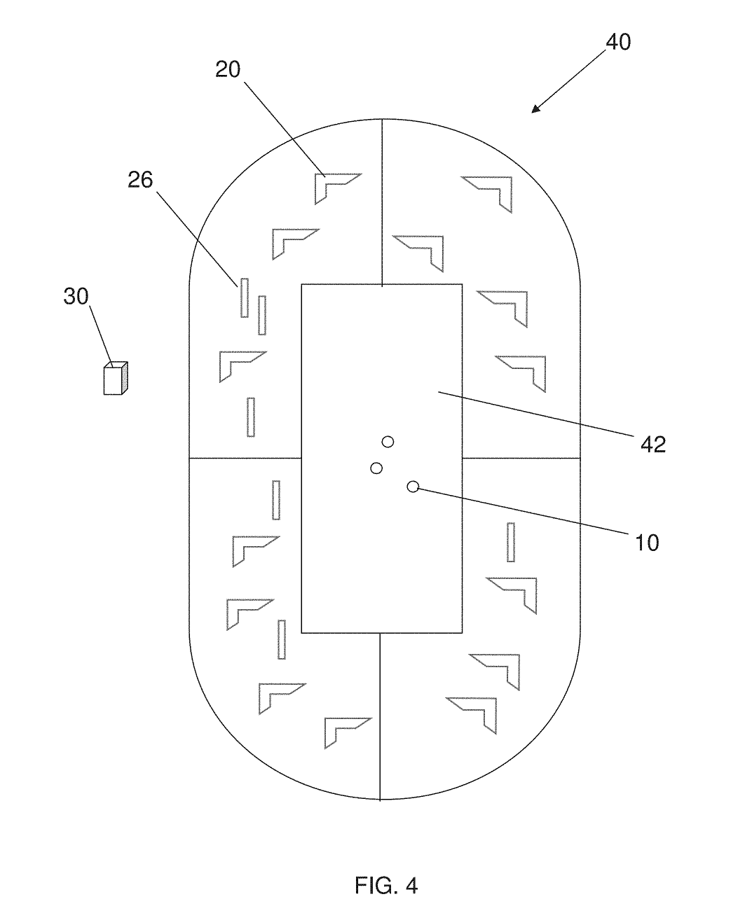

FIG. 4 is an illustration of a stadium venue 40 with a performance surface or playing field 42 and the seating divided into four sections for grouping participants in a target game competition. Individual participants are symbolized by dedicated target weapons 20 and by smartphones and tablets 26. Central computer 30 controls the game, and as described in FIG. 3 is networked with the players and with the targets 10. Prior to or during an event spectators in the stadium 40 may download an app to play in the targeting game.

The foregoing description is illustrative of particular embodiments of the invention, but is not meant to be a limitation upon the practice thereof.

1. A target gaming system comprising:
at least one target having an optical sensor, said at least one target adapted to move untethered around in a targeting area; and
at least one weapon emitting an optical signal recognized by said optical sensor for targeting said at least one target.

2. The system of claim 1 wherein said at least one target is attached to a robot.

3. The system of claim 1 wherein said at least one target can be controlled to do at least one of: change availability to a particular shooter, change scoring, change movement behavior, or become active.

4. The system of claim 1 wherein said target sensors include at least one of laser sensor or infra-red (IR) sensor.

5. The system of claim 4 wherein said target sensors are in communication with a central controller or a computing device by wireless connection.

6. The system of claim 1 wherein a series of lights on each of said at least one targets provide information to a player.

7. The system of claim 6 wherein said information provided by said series of lights comprises: lights that turn on when a target is active or turn off when the target is inactive, lights that change color to indicate which player scores when the target is hit where each player is assigned a color, lights that change color and/or flash/pulse to indicate point values of the target to be shot.

8. The system of claim 2 wherein said at least one targets rotate or move independently from the movement of said robot.

9. The system of claim 1 wherein said at least one targets move in a random fashion, or in a programmed sequence.

10. The system of claim 1 wherein the at least one weapon is a dedicated laser or infra-red (IR) gun or rifle.

11. The system of claim 1 wherein the at least one weapon is a smartphone or tablet device combined with a laser or IR source to form a gun.

12. The system of claim 11 wherein the smartphone or tablet serves as an information display for gamming parameters, a trigger means for the laser or IR source connected to the smartphone or tablet, a display source for augmented reality scenes, and as a target site for aiming at the at least one targets.

13. The system of claim 1 wherein the at least one weapon is a smartphone or tablet device that generates a focused light source to strike the at least one target.

14. The system of claim 13 wherein the focused light source is pulsed in a coded pattern to identify to the target which of the at least one weapons recorded a “hit”.

15. The system of claim 1 wherein the at least one weapon is a smartphone or tablet device where a set of camera optics of the smartphone or tablet is used to lock in on one of the at least one targets (target acquisition) and records a “target hit” without having to actually “fire” a laser or an IR beam.

16. The system of claim 15 wherein a tactile or haptic response is provided by the phone or tablet when one of the at least one targets has been acquired and hit.

17. The system of claim 1 wherein the at least one weapon is a head mounted weapon with heads up display (HUD) to aim and fire at the at least one targets, as well as view gaming statistics.

18. The system of claim 1 wherein an application (app) is downloaded to the at least one weapon to play versions of a targeting game.

19. The system of claim 1 wherein said at least one target has a movement behavior change algorithm based on skill of a player operating said at least one weapon to score against said at least one target.

20. A targeting game comprising: the targeting game system of claim 1 wherein a plurality of said at least one weapon are present and allocated to players to form teams and said targeting area is an arena or sporting venue.
